(19) United States
(12) Patent Application Publication
(10) Pub. No.: US 2018/0060218 A1
(43) Pub. Date: Mar. 1, 2018

(54) REMOTE CONTROL TESTING IN A DEVELOPMENT ENVIRONMENT

(71) Applicant: Le Technology, Inc. d/b/a LeEco, San Jose, CA (US)

(72) Inventor: Wei Li, San Diego, CA (US)

(21) Appl. No.: 15/245,120

(22) Filed: Aug. 23, 2016

(51) Int. Cl. G06F 11/36; G06F 9/44; G06F 9/445; H04N 17/00

(52) U.S. Cl. CPC G06F 11/3664; H04N 17/004; G06F 8/65; G06F 8/71

(57) ABSTRACT

A system comprising a device capable of transmitting wireless signals, a television including a processor, and a computing system capable of communicating with the television and the device. The computing system includes at least one processor programmed to: build an application executable by the television, output the application for execution at the television, output, to the device, signals to cause a sequence of wireless signals to be transmitted by the device, wherein the television is positioned to detect the sequence of wireless signals, receive, from the television, information about operations performed by the television, and determine, based at least on the information about operations performed by the television and information about the sequence of wireless signals, whether the television has operated improperly in response to the sequence of wireless signals.

### BACKGROUND

Modern televisions are sophisticated devices that perform much more than the traditional functions of a television. Today, a television can be thought of as a complete computer system, often running an operating system that not only provides functionality and an operating environment, but that also provides a platform for application software and software development.

Some software development practices involve frequent and automated integration and/or testing during development, so that any errors are detected quickly and early in the development process. To perform automated testing, software under development may perform a battery of self-tests, and independently determine whether it is operating properly. However, effectively testing a system that involves multiple independent and/or interacting components (e.g., a television and a remote control device) is difficult. In some cases, this difficulty arises from an inability to determine the effect of operations performed by one component on another component.

### SUMMARY

This disclosure is directed to techniques relating to the development, integration, and/or testing of software designed for execution on a modern television. Such techniques may include development, integration, and/or testing of software for a television that is capable of being controlled by a wireless device (e.g., a remote control device).

Some development teams employ a practice of continuous or near-continuous integration, which may involve integrating all of the individually tested software components developed by each member of the team and building an executable program from the components. Integration may be done frequently, such as daily or several times a day. In some examples, a computing system (sometimes referred to as an integration machine or integration server) may automatically and continuously monitor a source code repository for changes to the source code, and when a change is detected (e.g., updated source code is committed to the repository), the computing system may automatically compile, link, and build an executable program.

Often, the build process also includes automated tests designed to determine whether the new executable program operates properly, or at least, performs basic functions correctly. Performing such testing effectively for software designed to execute on a television may require testing the ability of the television to properly respond to commands from a remote control device. A computing system in accordance with one or more aspects of the present disclosure may interact with both the television and a remote control device that is used in the testing process. The computing system may send the executable program to the television and cause the executable program to start executing. The computing system may also cause the remote control device to send signals to the television being tested. The computing system may later receive from the television a report or log of operations performed by the television, and compare or reconcile that information with information about the signals sent by the remote control device. As a result, the computing system may determine whether the executable program has operated properly and/or whether the television has properly responded to signals transmitted by the remote control device.

In one example, a system comprises: a device capable of transmitting wireless signals; a television including a processor; and a computing system capable of communicating with the television and the device, wherein the computing system includes at least one processor programmed to: build an application executable by the television, output the application for execution at the television, output, to the device, signals to cause a sequence of wireless signals to be transmitted by the device, wherein the television is positioned to detect the sequence of wireless signals, receive, from the television, information about operations performed by the television, and determine, based at least on the information about operations performed by the television and information about the sequence of wireless signals, whether the television has operated improperly in response to the sequence of wireless signals.

In another example, a computer-readable storage medium comprises instructions that, when executed, cause at least one processor of a computing system to: build an application executable by a television; output the application for execution at the television; output, to the device, signals to cause a sequence of wireless signals to be transmitted by the device, wherein the television is positioned to detect the sequence of wireless signals; receive, from the television, information about operations performed by the television; and determine, based at least on the information about operations performed by the television and information about the sequence of wireless signals, whether the television has operated improperly in response to the sequence of wireless signals.

In another example, a method comprises: building, by a computer system, an application executable by a television; outputting, by the computer system, the application for execution at the television; outputting, to the device by the computer system, signals to cause a sequence of wireless signals to be transmitted by the device; receiving, by the computer system, from the television, information about operations performed by the television; and determining, by the computer system, based at least on the information about operations performed by the television and information about the sequence of wireless signals, whether the television has operated improperly in response to the sequence of wireless signals.

### BRIEF DESCRIPTION OF THE DRAWINGS

FIG. 1 is a conceptual diagram illustrating an example testing environment that may implement techniques for testing software in accordance with one or more aspects of the present disclosure.

FIG. 2 is a block diagram illustrating an example computing system, an example television, and an example remote control device that implements techniques for testing software in accordance with one or more aspects of the present disclosure.

FIG. 3A is a conceptual illustration of an example television operations log that may be generated by an example television in accordance with one or more aspects of the present disclosure.

FIG. 3B is a conceptual illustration of an example remote control operations log that may be used by an example computing system to determine whether an example television has operated properly in response to signals sent by an example remote control device in accordance with one or more aspects of the present disclosure.

FIG. 4 is a flowchart illustrating an example process of an example testing environment in accordance with one or more aspects of the present disclosure.

FIG. 5 is a flowchart illustrating an example process of an example computing system in accordance with one or more aspects of the present disclosure.

### DETAILED DESCRIPTION

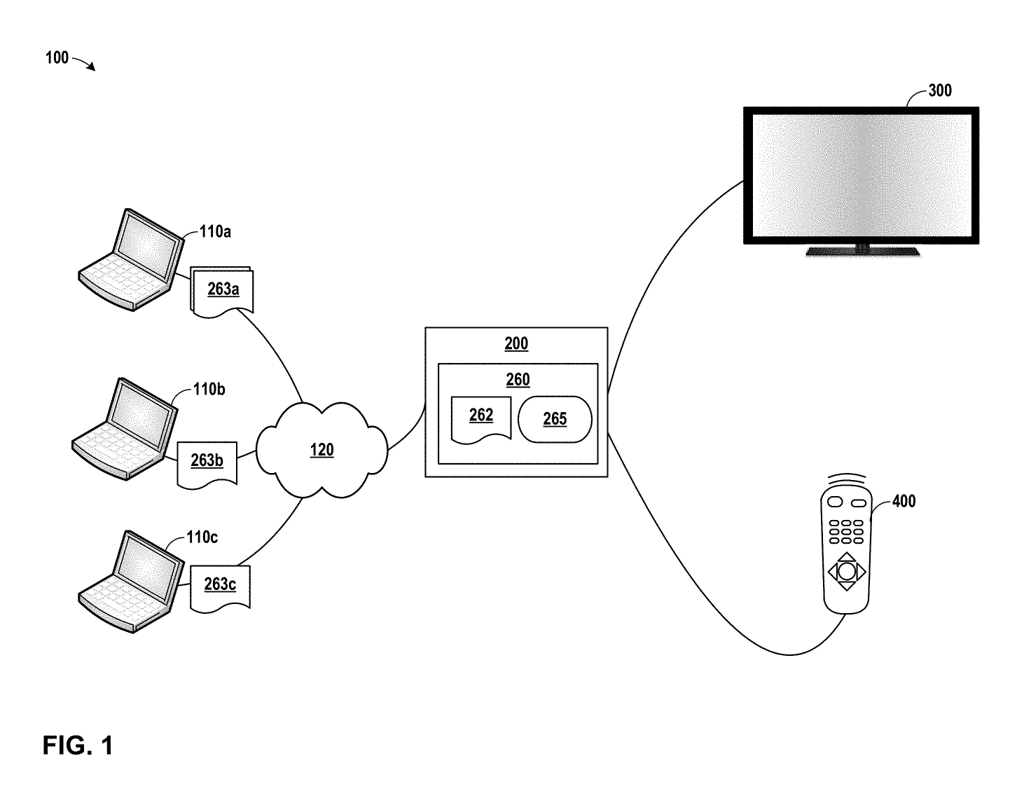

FIG. 1 is a conceptual diagram illustrating an example testing environment 100 that may implement techniques for testing software in accordance with one or more aspects of the present disclosure. In FIG. 1, testing environment 100 may include developer workstations 110, network 120, computing system 200, television 300, and remote control device 400.

One or more of developer workstations 110 may be operated or used by engineers, programmers, technicians, or others to develop, write, or create software for execution by one or more computer systems. Each of developer workstations 110 may include one or more processors, one or more storage devices, one or more input devices, one or more output devices, and other components. Each of developer workstations 110 may take the form of a desktop computer, laptop computer, workstation, tablet, smart phone, mobile device, server, appliance, thin client, and/or other type of computing device, including wearable, non-wearable, mobile, and/or non-mobile devices. In some examples, developer workstations 110 may include one or more application modules, which may include software development environments, including, without limitation, integrated development environments, development suites, web development environments, embedded system development environments, compilers, scripting environments, repositories, repository software, and/or source code management software. Each of developer workstations 110 may be connected to computing system 200 and/or other devices through network 120. One or more developer workstations 110 may also or alternatively be connected to computing system 200 and/or other devices in other ways. Network 120 may be a local area network, an intranet, a private internet, or part of the global Internet.

Computing system 200 may include one or more computing devices, such as servers, desktop computers, workstations, processors and/or other devices. Computing system 200 may perform operations in accordance with one or more aspects of the present disclosure using software, hardware, firmware, or a mixture of hardware, software, and firmware residing in and/or executing at computing system 200.

In some examples, computing system 200 may include an integration server, and may perform functions of a manual or continuous integration server. Computing system 200 may include repository 260. Source code 262 and executable program 265 may be stored in repository 260 or elsewhere within computing system 200.

Television 300 may be capable of presenting audio, visual, and/or video content to a viewer. Television 300 may include or serve as a computing device capable of performing operations in accordance with one or more aspects of the present disclosure using software, hardware, firmware, or a mixture of hardware, software, and firmware residing in and/or executing at television 300.

Remote control device 400 may be used to control one or more aspects of television 300 through wireless communication signals, including, without limitation, infrared and/or RF signals, or signals transmitted over a network. In some examples, remote control device 400 may be the remote control designed to be shipped and used by consumers with television 300. In such an example, remote control device 400 may include a capability for being controlled by an external computer system (e.g., computing system 200) in accordance with one or more aspects of the present disclosure. In other examples, remote control device 400 may be a specialized device designed for performing one or more testing functions in accordance with one or more aspects of the present disclosure. In other examples, remote control device 400 may also be a simple infrared or radio transmitter that converts electrical signals from computing system 200 to IR or RF or other signals for output. In other examples, remote control device 400 may also be general purpose computing device (e.g., a smartphone, tablet, or other computing device) that has been configured to perform one or more testing functions described herein in accordance with this disclosure.

In the example of FIG. 1, three programmers, developers, technicians, or other users, each operating one of developer workstation 110a, developer workstation 110b, or developer workstation 110c may modify source code 262. In some examples, such activity may be undertaken to add a feature to source code 262 or to fix a software bug in source code 262. Repository 260 of computing system 200 may maintain or store the source code 262. Source code 262 as stored in repository 260 may be the latest version or current working copy of source code 262. In other words, in some examples, repository 260 may maintain the mainline, trunk, or head version of source code 262.

In the example illustrated by FIG. 1, each of the developer workstations 110 may retrieve or check out source code working copies 263 of source code 262. Specifically, developer workstation 110a may retrieve source code working copy 263a from repository 260 of computing system 200. Developer workstation 110a may modify source code working copy 263a at the direction of the programmer operating developer workstation 110a. Similarly, developer workstation 110b may retrieve source code working copy 263b from repository 260 of computing system 200, and developer workstation 110b may modify source code working copy 263b at the direction of the programmer operating developer workstation 110b. Further, developer workstation 110c may retrieve source code working copy 263c from repository 260 of computing system 200, and developer workstation 110c may modify source code working copy 263c at the direction of the programmer operating developer workstation 110c.

As source code working copy 263a is modified at developer workstation 110a, developer workstation 110a may automatically, or at the direction of a programmer operating developer workstation 110a, create a build or an executable program from modified source code working copy 263a at developer workstation 110a. Developer workstation 110a may further test the build or executable in an attempt to verify that it is operating properly and is bug-free. Such testing may include subjecting the executable program created from source code working copy 263a to a series of tests. Developer workstation 110a may, automatically or at the direction of the programmer operating developer workstation 110a, continue to modify source code working copy 263a until the build from modified source code working copy 263a passes such tests at developer workstation 110a.

While source code working copy 263a is being modified at developer workstation 110a, other source code working copies 263 may be being modified by other developer workstations 110. For example, developer workstation 110b may concurrently or at another time modify source code working copy 263b and create a build or an executable program from source code working copy 263b at the direction of another programmer, and developer workstation 110b may also test the build or executable to ensure that it works properly at developer workstation 110b. Similarly, developer workstation 110c may concurrently or at another time modify source code working copy 263c and create a build or an executable program from source code working copy 263c at the direction of another programmer, and developer workstation 110c may also test the build or executable program to ensure that it works properly at developer workstation 110c.

Referring again to developer workstation 110a, once a build has been created from source code working copy 263a and has passed tests that suggest that it operates properly at developer workstation 110a, developer workstation 110a may, at the direction of the developer operating developer workstation 110a, commit the modified source code working copy 263a to repository 260 of computing system 200, and/or cause source code working copy 263a to be copied to repository 260 of computing system 200. However, in the example of FIG. 1, because multiple developer workstations 110 may be modifying source code 262 at the same time, source code 262 may have changed by the time that source code working copy 263a is ready to be committed or copied to repository 260 of computing system 200.

Therefore, in some examples, before developer workstation 110a commits or copies source code working copy 263a to repository 260 of computing system 200, developer workstation 110a may, at the direction of the developer operating developer workstation 110a, update source code working copy 263a to include any changes that have been made to source code 262 since source code working copy 263a was received by developer workstation 110a. In some examples, the portions of source code 262 modified by each of developer workstation 110a, developer workstation 110b, and developer workstation 110c may be different so that, for example, the same code files or at least the same lines of code are not being modified at the same time, thereby easing the process of updating source code working copy 263a to include any changes made by other developers. (In other words, developers at developer workstations 110 may work on different portions of source code 262.) Once changes made by other developers are included in source code working copy 263a, developer workstation 110a may automatically, or at the direction of a programmer operating developer workstation 110a, create another build or another executable program from the updated source code working copy 263a at developer workstation 110a. Developer workstation 110a may, at the direction of the programmer operating developer workstation 110a, continue to modify source code working copy 263a at developer workstation 110a and synchronize with changes made by other developers until the build from the updated source code working copy 263a passes such tests based on all current revisions to source code 262.

Once developer workstation 110a creates a build based on the updated source code working copy 263a that has been properly synchronized with all of the latest updates to source code 262, and that also has satisfactorily passed tests for proper operation at developer workstation 110a, developer workstation 110a may commit the updated source code working copy 263a to repository 260 of computing system 200, and/or cause source code working copy 263a to be copied to repository 260 of computing system 200. In some examples, source code working copy 263a is copied to source code 262 and source code working copy 263a becomes the latest version of source code 262.

When source code 262 is updated, computing system 200 may build a new executable program 265 from updated source code 262 either automatically, or at the direction of a user (e.g., the programmer operating 110a). Since source code 262 was tested at developer workstation 110a, it may be expected to build correctly and may be expected to pass all tests for proper operation, but computing system 200 nevertheless integrates all the individually tested software components and again tests the integrated whole as executable program 265. Performing integration at computing system 200 may ensure that source code 262 has been properly debugged, integrated, and synchronized, and integrating at computing system 200 helps ensure that successful tests completed at developer workstation 110a are not the result of a dependency or configuration present at developer workstation 110a, but not present in other environments.

Computing system 200 may test executable program 265 by performing tests that tend to ensure that executable program 265 operates properly on television 300. In some examples, testing performed at computing system 200 may include computing system 200 copying, sending, or otherwise communicating executable program 265 to television 300 for execution. Television 300 may perform a series of tests that are included within executable program 265 and/or that are included within another module of television 300.

Testing television 300 effectively may require testing the ability of television 300 to respond properly to signals from a remote control device, such as remote control device 400. Including such tests in a continuous integration test environment may be difficult or more complicated than internal tests that may be automatically and simply performed by television 300 without having to test the response of television 300 to external stimuli, because television 300 and remote control device 400 operate independently, with limited communication between television 300 and remote control device 400. For example, television 300 executing executable program 265 may be unable to control remote control device 400 in order to test the response of television 300 to signals from remote control device 400. In some examples, it may therefore be difficult for either television 300 or remote control device 400 to determine whether television 300 has properly interpreted and/or properly responded to a signal transmitted by remote control device 400. Therefore, in accordance with one or more aspects of the present disclosure, computing system 200 may be used to perform tests that involve both television 300 and remote control device 400.

In some examples, computing system 200 may send signals (e.g., electrical signals) to remote control device 400, and remote control device 400 transforms such signals into IR signals that are transmitted for detection by television 300. In some examples, such signals sent by computing system 200 may be in the form of a command interpreted by remote control device 400 that remote control device 400 translates into the corresponding IR signal. In other examples, such signals sent by computing system 200 may be simple electrical signals for direct or relatively direct transformation by an IR transmitter into IR signals.

In some examples, computing system 200 may copy, send, or communicate to remote control device 400 a script of tests that may be performed by remote control device 400 to test for proper interaction between television 300 and remote control device 400 and other operations. In the example of FIG. 1, such a script of tests may cause remote control device 400 to send various signals that television 300 may receive and process. Television 300 may perform one or more operations in response to such signals. Further, television 300 may create a log of operations or other report of signals received and operations performed by television 300. During or after testing, television 300 may send the log of operations to computing system 200 for evaluation. Computing system 200 may determine, based on the operations performed as reported by television 300, and based on information about the operations and/or signals sent to television 300 by remote control device 400 (e.g., pursuant to the test script), whether executable program 265 and/or television 300 has successfully completed testing, and/or whether television 300 and/or executable program 265 have not operated properly.

If computing system 200 determines that executable program 265 and/or television 300 have successfully completed testing, source code 262 may become the latest version of source code 262, and may thereafter be used by programmers, such as those operating developer workstations 110 for further development. If computing system 200 determines that executable program 265 and/or television 300 has not operated properly, computing system 200 may automatically, or at the direction of a programmer or other user, revert source code 262 back to the last-known build or version of source code 262 that successfully completed testing; the version of source code 262 that failed to pass all tests may then be evaluated and/or debugged elsewhere.

In some examples, while television 300 and remote control device 400 are evaluating executable program 265 for proper operation, developer workstations 110 might not be able to check out any source code working copies 263 until executable program 265 either passes or fails the series of tests performed by television 300 and remote control device 400, and/or in other examples, developer workstations 110 might not be able to commit changes made to source code working copies 263 to source code 262 in repository 260. Accordingly, for this reason and/or for other reasons, the tests performed by television 300 and remote control device 400 may be configured so that they can be performed quickly and at least in some cases without human input or intervention, and such tests may in some examples be relatively simple tests designed to test more basic operations and verify the basic integrity and operation of the commit build, and might not exhaustively test the build. In some examples, a series of tests that can be completed in roughly five minutes or ten minutes may be considered acceptable to some development teams. In other examples, a series of tests that lasts an hour or more might be considered unacceptable.

In some examples, more exhaustive tests of television 300 and/or remote control device 400, after an initial set of commit tests, may be performed as part of a staged build and test process, after verifying operation of the commit build. In such an example, the commit build may quickly test enough basic operations to ensure that it is stable enough for other developers to use as a basis for further development, but more extensive tests may be performed on executable program 265 after making the updated commit version of source code 262 available for further development.

In some examples, the process of building, integrating, and/or testing by computing system 200 is performed frequently, such as daily, and in some examples, multiple times per day. More extensive tests, such as those performed in a staged build process, may be performed less frequently, such as nightly.

For development projects where multiple developers make contributions to the source code 262, the work of those multiple developers, often in the form of individually-tested software components, eventually is combined into an integrated whole and then tested and debugged as described. This process can often be one of the most difficult and time-consuming parts of software development, because bugs arising from how one component works with another may be difficult to identify, and may involve source code written by more than one person. But by performing integration frequently, and in some examples, in an automated fashion, integration becomes an easier process. Where integration is performed after only incremental changes are made to source code 262, any bugs, errors, or problems with source code 262 are discovered quickly, making such problems and/or bugs easier to pinpoint and resolve.

Further, computing system 200 may test interactions between television 300 and remote control device 400, and as a result, more effectively test source code 262. Also, because computing system 200 may perform tests involving both television 300 and remote control device 400 in an automated manner, i.e., without human control over or human input to the remote control device 400 during the testing procedure, and also evaluate the results of such tests in an automated manner, computing system 200 may include such tests as part of an automated build process. Using an automated build process enables computing system 200 to frequently test and evaluate interactions between television 300 and remote control device 400 in conjunction with frequent integrations. Accordingly, testing environment 100 may enable more efficient and effective development of stable and/or bug-free software for television 300. As a result, television 300 may operate more effectively, and result in a more pleasant user experience for a consumer watching television 300.

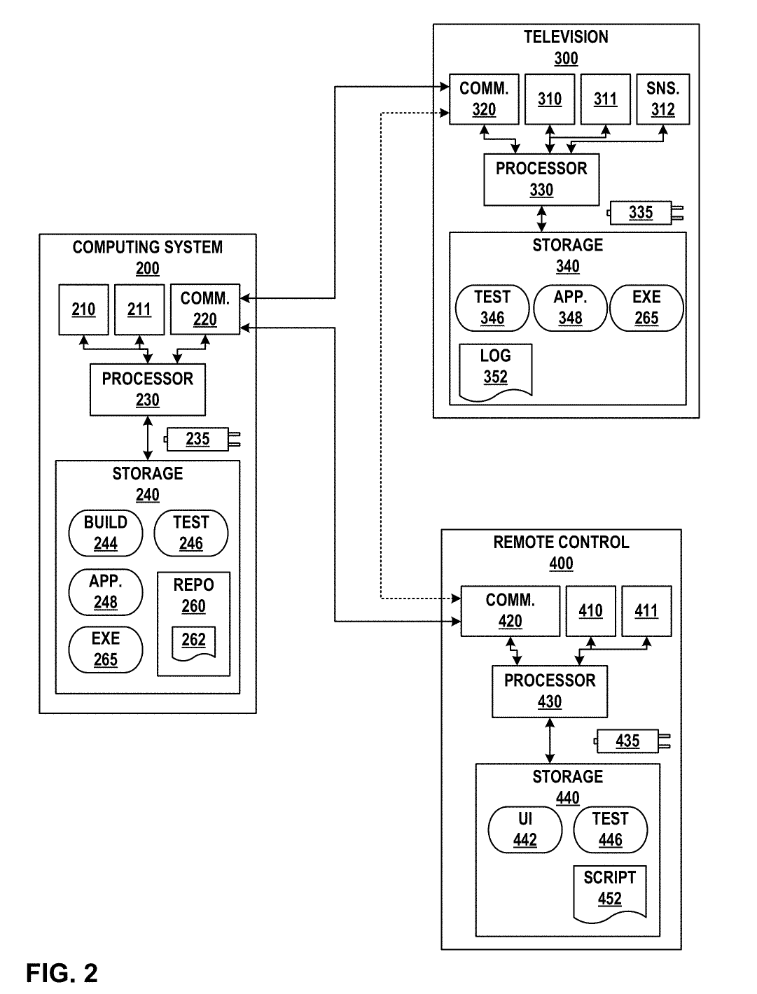

FIG. 2 is a block diagram illustrating an example computing system 200, an example television 300, and an example remote control device 400 that implements techniques for testing software in accordance with one or more aspects of the present disclosure. Each of computing system 200, television 300, and remote control device 400 are described below in the context of FIG. 1. FIG. 2 illustrates only examples of computing system 200, television 300, and remote control device 400, and many other examples of computing system 200, television 300, and remote control device 400 may be used in other instances and each may include a subset of the components shown in FIG. 2, and/or each may include additional components not shown in FIG. 2.

Computing system 200 may include one or more input devices 210, one or more output devices 211, one or more communication units 220, one or more processors 230, and one or more storage devices 240. Computing system 200 may also include power source 235.

One or more input devices 210 of computing system 200 may generate, receive, or process input. Such input may include input from a keyboard, pointing device, voice responsive system, video camera, button, sensor, mobile device, control pad, microphone, presence-sensitive screen, network, or any other type of device for detecting input from a human or machine.

One or more output devices 211 may generate, receive, or process output. Examples of output are tactile, audio, visual, and/or video output. Output devices 211 of computing system 200 may include a display, sound card, video graphics adapter card, speaker, presence-sensitive screen, one or more USB interfaces, video and/or audio output interfaces, or any other type of device capable of generating tactile, audio, video, or other output. A display output device may include a cathode ray tube (CRT) monitor, liquid crystal display (LCD), Light-Emitting Diode (LED) display, or any other type of display device.

Power source 235 may provide power to one or more components of computing system 200. Power source 235 may receive power from the primary alternative current (AC) power supply in a building, home, or other location. In other examples, power source 235 may also be a battery. In still further examples, computing system 200 and/or power source 235 may receive power from another source.

One or more communication units 220 of computing system 200 may communicate with devices external to computing system 200 by transmitting and/or receiving data. In some examples, communication units 220 may communicate with television 300 and/or remote control device 400 over a network. In other examples, communication units 220 may send and/or receive radio signals on a radio network such as a cellular radio network. In other examples, communication units 220 may transmit and/or receive satellite signals on a satellite network such as a Global Positioning System (GPS) network. Examples of communication units 220 include a network interface card (e.g. such as an Ethernet card), an optical transceiver, a radio frequency transceiver, a GPS receiver, or any other type of device that can send and/or receive information. Other examples of communication units 220 may include Bluetooth®, GPS, 3G, 4G, and Wi-Fi® radios found in mobile devices as well as Universal Serial Bus (USB) controllers and the like.

One or more processors 230 may implement functionality and/or execute instructions associated with computing system 200. Examples of processors 230 include microprocessors, application processors, display controllers, auxiliary processors, one or more sensor hubs, and any other hardware configured to function as a processor, a processing unit, or a processing device. Computing system 200 may use one or more processors 230 to perform operations in accordance with one or more aspects of the present disclosure using software, hardware, firmware, or a mixture of hardware, software, and firmware residing in and/or executing at computing system 200.

One or more storage devices 240 within computing system 200 may store information for processing during operation of computing system 200. In some examples, one or more storage devices 240 are temporary memories, meaning that a primary purpose of the one or more storage devices is not long-term storage. Storage devices 240 on computing system 200 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 240, in some examples, also include one or more computer-readable storage media. Storage devices 240 may be configured to store larger amounts of information than volatile memory. Storage devices 240 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. Storage devices 240 may store program instructions and/or data associated with one or more of the modules described in accordance with one or more aspects of this disclosure.

One or more processors 230 and one or more storage devices 240 may provide an operating environment or platform for one or one more modules, which may include a combination of hardware, firmware, and software. For instance, one or more processors 230 may execute instructions and one or more storage devices 240 may store instructions and/or data of one or more modules. The combination of processors 230 and storage devices 240 may retrieve, store, and/or execute the instructions and/or data of one or more applications, modules, or software. Processors 230 and/or storage devices 240 may also be operably coupled to one or more other software and/or hardware components, including, but not limited to, one or more of the components illustrated in FIG. 2.

Build module 244 may operate to build one or more executable programs 265 from source code 262 in accordance with one or more aspects of the present disclosure. In some examples, build module 244 may include development environments, compilers, source code management tools, configuration management tools, version control systems, repository logic, tool sets, suites, and/or utilities and other types of utilities or functionality. Executable program 265 may be an executable built, compiled, linked, and/or created by build module 244.

Test module 246 may operate to test functionality of one or more modules or executable programs in accordance with one or more aspects of the present disclosure. Test module 246 may operate to test functionality of executable program 265 in accordance with one or more aspects of the present disclosure.

One or more application modules 248 may represent some or all of the other various individual applications and services executing at and accessible from computing system 200. A user of computing system 200 may interact with a graphical user interface associated with one or more application modules 248 to cause computing system 200 to perform a function. Numerous examples of application modules 248 may exist and may include development environments, test environments, source code management tools and environments, network applications, an internet browser application, or any and all other applications that may execute at computing system 200.

Repository 260 may include storage used or maintained by build module 244, test module 246, one or more application modules 248, or source code management tools. Source code 262 may be stored in repository 260, and in some examples, repository 260 may maintain the latest or most recent version of source code 262. In some examples, repository 260 may maintain additional versions of source code 262 and/or executable program 265.

Although certain modules, components, programs, executables, data items, functional units, and/or other items included within storage device 240 may have been illustrated separately, one or more of such items could be combined and operate as a single module, component, program, executable, data item, or functional unit. For example, one or more modules may be combined or partially combined so that they operate or provide functionality as a single module. Further, one or more modules may operate in conjunction with one another so that, for example, one module acts as a service or an extension of another module. Also, each module, component, program, executable, data item, functional unit, or other item illustrated within storage device 240 may include multiple components, sub-components, modules, sub-modules, and/or other components or modules not specifically illustrated.

Television 300 may include one or more input devices 310, one or more output devices 311, one or more sensors 312, one or more communication units 320, one or more processors 330, power source 335, and one or more storage devices 340.

One or more input devices 310 of television 300 may generate, receive, or process input. Such input may include input from a set-top box, keypad or joystick included within or on the housing of television 300, or from a keyboard, pointing device, network, voice responsive system, video camera, button, sensor, mobile device, control pad, microphone, presence-sensitive screen, or any other type of device for detecting input from a human or machine.

One or more output devices 311 may generate, receive, or process output. In general, television 300 may include a large display for presenting video content. However, other output may include tactile, audio, visual, and/or other video output. Output devices 311 of television 300 may include a display, sound card, video graphics adapter card, speaker, presence-sensitive screen, one or more USB interfaces, video and/or audio output interfaces, or any other type of device capable of generating tactile, audio, video, or other output. The display output device for television 300 may include a cathode ray tube (CRT) monitor, liquid crystal display (LCD), Light-Emitting Diode (LED) display, or any other type of display device.

Power source 335 may provide power to one or more components of television 300. Power source 335 may receive power from the primary alternative current (AC) power supply in a building, home, or other location. In other examples, power source 335 may include, or be supplemented by a battery. In still further examples, television 300 and/or power source 335 may receive power from another source.

One or more communication units 320 of television 300 may communicate with devices external to television 300 by transmitting and/or receiving data. In some examples, communication units 320 may communicate with computing system 200 over a network or a direct wired connection (e.g., solid line in FIG. 2), and communication units 320 may communicate with remote control device 400 through wireless communication, such as infrared or radio signals (e.g., dotted line in FIG. 2). In other examples, communication units 320 may send and/or receive radio signals on a radio network such as a cellular radio network. In other examples, communication units 320 may transmit and/or receive satellite signals on a satellite network such as a Global Positioning System (GPS) network. Examples of communication units 320 include a network interface card (e.g. such as an Ethernet card), an optical transceiver, a radio frequency transceiver, a GPS receiver, or any other type of device that can send and/or receive information. Other examples of communication units 320 may include Bluetooth®, GPS, 3G, 4G, and Wi-Fi® radios found in mobile devices as well as Universal Serial Bus (USB) controllers and the like.

One or more processors 330 may implement functionality and/or execute instructions associated with television 300. Examples of processors 330 include microprocessors, application processors, display controllers, auxiliary processors, one or more sensor hubs, and any other hardware configured to function as a processor, a processing unit, or a processing device. Television 300 may use one or more processors 330 to perform operations in accordance with one or more aspects of the present disclosure using software, hardware, firmware, or a mixture of hardware, software, and firmware residing in and/or executing at television 300.

One or more storage devices 340 within television 300 may store information for processing during operation of television 300. In some examples, one or more storage devices 340 are temporary memories, meaning that a primary purpose of the one or more storage devices is not long-term storage. Storage devices 340 on television 300 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 340, in some examples, also include one or more computer-readable storage media. Storage devices 340 may be configured to store larger amounts of information than volatile memory. Storage devices 340 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. Storage devices 340 may store program instructions and/or data associated with one or more of the modules described in accordance with one or more aspects of this disclosure.

One or more processors 330 and one or more storage devices 340 may provide an operating environment or platform for one or one more modules, which may include a combination of hardware, firmware, and software. For instance, one or more processors 330 may execute instructions and one or more storage devices 340 may store instructions and/or data of one or more modules. The combination of processors 330 and storage devices 340 may retrieve, store, and/or execute the instructions and/or data of one or more applications, modules, or software. Processors 330 and/or storage devices 340 may also be operably coupled to one or more other software and/or hardware components, including, but not limited to, one or more of the components illustrated in FIG. 2.

Test module 346 may operate to test functionality of one or more modules or executable programs in accordance with one or more aspects of the present disclosure. Test module 346 may operate to test functionality of executable program 265.

One or more application modules 348 may represent some or all of the other various individual applications and services executing at and accessible from television 300. A user of television 300 may interact with a graphical user interface associated with one or more application modules 348 to cause television 300 to perform a function. Numerous examples of application modules 348 may exist and may include a remote control application, a television application, a video streaming application, a fitness application, a calendar application, a personal assistant or prediction engine, a search application, a map or navigation application, a transportation service application (e.g., a bus or train tracking application), a social media application, a game application, an e-mail application, a chat or messaging application, an internet browser application, or any and all other applications that may execute at television 300.

Although certain modules, components, programs, executables, data items, functional units, and/or other items included within storage device 340 may have been illustrated separately, one or more of such items could be combined and operate as a single module, component, program, executable, data item, or functional unit. For example, one or more modules may be combined or partially combined so that they operate or provide functionality as a single module. Further, one or more modules may operate in conjunction with one another so that, for example, one module acts as a service or an extension of another module. Also, each module, component, program, executable, data item, functional unit, or other item illustrated within storage device 240 may include multiple components, sub-components, modules, sub-modules, and/or other components or modules not specifically illustrated.

Remote control device 400 may include one or more input devices 410, one or more output devices 411, one or more communication units 420, one or more processors 430, power source 435, and one or more storage devices 440.

One or more input devices 410 of remote control device 400 may generate, receive, or process input. Such input may include input from a keypad or from signals received from computing system 200. However, input devices 410 may include other devices of the type described in connection with computing system 200 and television 300. Input device 410 may include a presence-sensitive input panel, which may include a resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology. Such a presence-sensitive panel may detect user input, and may also serve as a display device.

One or more output devices 411 may generate, receive, or process output. Such output may include tactile, audio, visual, and/or other video output. Output devices 411 of remote control device 400 may include a display, sound card, video graphics adapter card, speaker, presence-sensitive screen, one or more USB interfaces, video and/or audio output interfaces, or any other type of device capable of generating tactile, audio, video, or other output. Output devices 411 may include the presence-sensitive panel described above in connection with input devices 410, and such a panel may include a display for presenting output.

Power source 435 may provide power to one or more components of remote control device 400. Power source 435 may receive power from a battery. In other examples, remote control device 400 and/or power source 435 may receive power from another source, including from the primary alternative current (AC) power supply in a building, home, or other location.

One or more communication units 420 of remote control device 400 may communicate with devices external to remote control device 400 by transmitting and/or receiving data. In some examples, communication units 420 may communicate with computing system 200 over a network or direct wired connection (solid line in FIG. 2), and communication units 420 may communicate with television 300 through wireless communication, such as infrared or radio signals (dotted line in FIG. 2). In other examples, communication units 420 may send and/or receive radio signals on a radio network such as a cellular radio network. In other examples, communication units 420 may transmit and/or receive satellite signals on a satellite network such as a Global Positioning System (GPS) network. Examples of communication units 420 include a network interface card (e.g. such as an Ethernet card), an optical transceiver, a radio frequency transceiver, a GPS receiver, or any other type of device that can send and/or receive information. Other examples of communication units 420 may include Bluetooth®, GPS, 3G, 4G, and Wi-Fi® radios found in mobile devices as well as Universal Serial Bus (USB) controllers and the like.

One or more processors 430 may implement functionality and/or execute instructions associated with remote control device 400. Examples of processors 430 include microprocessors, application processors, display controllers, auxiliary processors, one or more sensor hubs, and any other hardware configured to function as a processor, a processing unit, or a processing device. Remote control device 400 may use one or more processors 430 to perform operations in accordance with one or more aspects of the present disclosure using software, hardware, firmware, or a mixture of hardware, software, and firmware residing in and/or executing at remote control device 400.

One or more storage devices 440 within remote control device 400 may store information for processing during operation of remote control device 400. In some examples, one or more storage devices 440 are temporary memories, meaning that a primary purpose of the one or more storage devices is not long-term storage. Storage devices 440 on remote control device 400 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 440, in some examples, also include one or more computer-readable storage media. Storage devices 440 may be configured to store larger amounts of information than volatile memory. Storage devices 440 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. Storage devices 440 may store program instructions and/or data associated with one or more of the modules described in accordance with one or more aspects of this disclosure.

One or more processors 430 and one or more storage devices 440 may provide an operating environment or platform for one or one more modules, such as a combination of hardware, firmware, and software. For instance, one or more processors 430 may execute instructions and one or more storage devices 440 may store instructions and/or data of one or more modules. The combination of processors 430 and storage devices 440 may retrieve, store, and/or execute the instructions and/or data of one or more applications, modules, or software. Processors 430 and/or storage devices 440 may also be operably coupled to one or more other software and/or hardware components, including, but not limited to, one or more of the components illustrated in FIG. 2.

Ui module 442 may manage user interactions with input devices 410 and output devices 411 and other components of remote control device 400. In some examples, ui module 442 may act as an intermediary between various components of remote control device 400 to make determinations based on user input detected by one or more input devices 410 and generate output at one or more output devices 411 and/or communication units 420 in response to the user input. Ui module 442 may receive instructions from an application, service, platform, script, or other module of remote control device 400 and may respond by performing one or more operations.

Test module 446 may operate to send signals so as to test functionality of one or more modules or executable programs at executing at television 300 in accordance with one or more aspects of the present disclosure. Test module 446 may operate to test functionality of executable program 265 as executable program 265 executes at television 300 in accordance with one or more aspects of the present disclosure. In some examples, test module 446 may cause communication unit 420 to send signals intended for television 300 in a one-way communication with television 300. In other examples, test module 346 may be configured to both send signals and receive signals via communication unit 420, thereby enabling interactive communication with other devices, including television 300.

Although certain modules, components, programs, executables, data items, functional units, and/or other items included within storage device 440 may have been illustrated separately, one or more of such items could be combined and operate as a single module, component, program, executable, data item, or functional unit. For example, one or more modules may be combined or partially combined so that they operate or provide functionality as a single module. Further, one or more modules may operate in conjunction with one another so that, for example, one module acts as a service or an extension of another module. Also, each module, component, program, executable, data item, functional unit, or other item illustrated within storage device 240 may include multiple components, sub-components, modules, sub-modules, and/or other components or modules not specifically illustrated.

In operation, computing system 200 may build executable program 265 in response to executable program 265 being updated by one or more of developer workstations 110. For example, communication unit 220 may detect input from one or more of developer workstations 110. Communication unit 220 may output to build module 244 an indication of input. Build module 244 may determine, based on the indication of input, one or more files, signals, or other communications received from one or more developer workstations 110. Build module 244 may also, based on the indication of input, update source code 262 or determine that source code 262 has been updated. Build module 244 may automatically, or at the direction of a user, create executable program 265 from source code 262.

If build module 244 is able to successfully build executable program 265, computing system 200 may send executable program 265 to television 300. Computing system 200 may send the executable 265 to television 300 automatically in response to determining the build module 244 is able to successfully build executable program 265. Build module 244 of computing system 200 may cause communication unit 220 to communicate executable program 265 to television 300. Communication unit 320 of television 300 may, as a result, detect input and output to test module 346 an indication of input. Test module 346 may determine that the input corresponds to executable program 265 being received from computing system 200, and test module 346 may cause executable program 265 to be stored in storage device 340.

In some examples, test module 346 may cause executable program 265 to execute on television 300, and may cause executable program 265 to perform tests to verify its operation on television 300. Such tests may be included as part of executable program 265 and/or such tests may be included as part of test module 346. As tests are performed, information may be written to log 352, and such information may include details about the tests performed, and any results of such tests. Such tests may include those that might not require responding to signals received from remote control device 400.

Television 300 may operate to perform further tests of executable program 265, including tests that require television 300 to respond to signals generated by remote control device 400. Computing system 200 may send a sequence of signals to remote control device 400 that are translated, interpreted, converted, and/or relayed to television 300. For instance, test module 246 may cause communication unite 220 to send a signal to remote control device 400. Communication unit 420 of remote control device 400 may detect input and transform the signal into an IR signal. Communication unit 420 may transmit the IR signal for detection by television 300. In such an example, remote control device 400 may operate as a simple relay for signals generated by computing system 200. In response, communication unit 320 of television 300 may detect input and output an indication of input to executable program 265. Executable program 265 may determine, based on the indication of input, an operation (e.g., change channel of television 300, adjust volume of television 300, adjust brightness of television 300). Executable program 265 may cause television 300 to perform the operation. Executable program 265 and/or test module 346 may log information about the indication of input and the operation performed in log 352. Television 300 may also communicate information about the indication of input and the operation performed to computing system 200.

In another example, test module 246 may cause communication unit 220 to send a signal to remote control device 400 to start a script of tests, such as test script 452. Communication unit 420 of remote control device 400 may detect input and may output to test module 446 an indication of input that test module 446 determines corresponds to a request to start test script 452. Test module 446 may start test script 452, which may cause communication unit 420 to communicate various signals. In response, communication unit 320 of television 300 may detect input and output an indication of input to executable program 265. Executable program 265 may determine, based on the indication of input, an operation (e.g., change channel of television 300, adjust volume of television 300, adjust brightness of television 300). Executable program 265 may cause television 300 to perform the operation. Executable program 265 and/or test module 346 may log information about the indication of input and the operation performed in log 352. Television 300 may also communicate information about the indication of input and the operation performed to computing system 200.

In another example, test module 246 may cause communication unit 220 to send a script of tests over communication unit 220 to remote control device 400. Communication unit 420 of remote control device 400 may detect input and output to test module 446 an indication of input that test module 446 determines corresponds to a script of tests. Test module 446 may store the script of tests in storage device 440 as test script 452 (or, in another example, as a second set of tests). Test module 446 may start test script 452, which may cause communication unit 420 to communicate various signals for testing purposes. In response, communication unit 320 of television 300 may detect input and output an indication of input to executable program 265. Executable program 265 may determine, based on the indication of input, one or more operations, executable program 265 may cause television 300 to perform the operation(s), and executable program 265 and/or test module 346 may report information about the indication of input and the operation performed in log 352.

In some examples, sensor 312 may detect input from one or more output devices 311, and may output to test module 346 one or more indications of input. For instance, one or more of the operations that may be performed by television 300 may cause the picture quality or attributes of a display device to be changed. To verify that television 300 properly performed such operations, sensor 312 may be used to detect at least some of characteristics of such a display device. Sensor 312 may detect input corresponding to such characteristics, and output to test module 346 and/or executable program 265 an indication of input. Test module 346 and/or executable program 265 may determine that the indications of input correspond to information about a picture, video, brightness. Test module 346 and/or executable program 265 may evaluate such information to assess whether one or more operations have been performed by television 300 properly. Test module 346 may include such information, or information derived from such information, in log 352, and may report information in log 352 to computing system 200.

Television 300 may determine, based on a signal received from computing system 200 or remote control device 400 or otherwise, that tests have been completed. For example, communication unit 320 may detect input and may output an indication of input to test module 346. Test module 346 may determine that the indication of input corresponds to an indication that remote control device 400 has completed tests within test script 452. In another example, test module 346 may detect input from executable program 265 indicating that tests are completed. In another example, test module 346 may determine that tests have been completed based on information included in log 352. In another example, test module 346 may determine that tests have been completed in response to a signal sent by computing system 200 and received by television 300. In other examples, test module 346 may determine that tests have been completed in other ways.

In response to determining that tests have been completed, test module 346 may format log 352 for sending to computing system 200, and may cause communication unit 320 to send log 352 to computing system 200. Communication unit 220 of computing system 200 may detect input, and output to test module 246 an indication of input that test module 246 determines corresponds to the information in log 352. Test module 346 may store such information in storage device 240.

Test module 246 of computing system 200 may evaluate the information received from television 300 that corresponds to log 352 to determine whether television 300, executable program 265, and/or remote control device 400 have successfully completed one or more series of tests. Based on this determination, test module 346 may generate output in the form of a report, an email, a visual display, or another form of output indicating the results of the tests.

In some examples, if the tests have been completed successfully, test module 246 may cause source code 262 to become the basis on which further software modifications are performed by one or more developer workstations 110. In some examples in such a situation, test module 246 may cause source code 262 to become the new mainline. In other examples, if the tests have not been completed successfully, test module 246 may cause source code 262 to revert back to the last-known build or version of source code 262 that successfully passed testing.

In another example, rather than remote control device 400 executing test script 452, computing system 200 may control remote control device 400 to test interactions between remote control device 400 and television 300. For example, test module 246 may cause communication unit 220 to send a signal to remote control device 400. Communication unit 420 of remote control device 400 may detect the signal, and output an indication of input to test module 446. Test module 446 may determine that the indication of input corresponds to a particular signal or command (e.g., change channel, adjust volume). Test module 446 may cause communication unit 420 to generate a signal that is detected by communication unit 320 of television 300. Communication unit 320 may output to executable program 265 an indication of input that executable program 265 determines corresponds to an operation. Executable program 265 may cause television 300 to perform the operation. Executable program 265 and/or test module 346 may report information about the indication of input and/or the operation performed in log 352. Computing system 200 may continue to send signals to remote control device 400, which may cause remote control device 400 to send signals to television 300 as part of a series of tests.

In another example, computing system 200 may control remote control device 400 to test how television 300 responds to signals sent to remote control device 400, and computing system 200 may receive information about operations performed by television 300 as television 300 performs such operations. For example, computing system 200 may cause remote control device 400 to send a signal to television 300, causing television 300 to perform an operation. Test module 346 of television 300 may log information about the signal received and the operation performed in log 352. Test module 346 may also cause communication unit 320 to send information to computing system 200 about the signal received and the operation performed by television 300. Communication unit 220 of computing system 200 may detect the signal and output an indication of input to test module 246. Test module 246 may determine, based on the indication of input, that the signal corresponds to information about the signal received and the operation performed by television 300. In this way, computing system 200 may receive feedback from television 300 after one or more operations, and may use such information determine further appropriate testing. Computing system 200 may adjust the signals sent to remote control device 400 and/or determine whether to continue or abort further testing.

Test module 346 may determine that testing has been completed. Test module 346 may format log 352 for sending to computing system 200, and may cause communication unit 320 to send log 352 to computing system 200. Communication unit 220 of computing system 200 may detect input, and output to test module 246 an indication of input that test module 246 determines corresponds to the information in log 352. Test module 246 may store such information in storage device 240. Test module 246 may further evaluate such information to determine whether television 300, executable program 265, and/or remote control device 400 have operated properly. Based on this determination, test module 246 may generate output indicating the results of the tests.

In the examples described remote control device 400 and television 300 may communicate in a one-way manner, with remote control device 400 sending signals to television 300, and television 300 performing an operation in response to such signals. In such examples, television 300 might not send any signals to remote control device 400, and/or might not send a signal to remote control device 400 in response to signals television 300 receives from remote control device 400. In other examples, however, television 300 and remote control device 400 may engage in interactive or two-way communications, and television 300 may, for example, send an acknowledgement of one or more signals it receives from remote control device 400. In such examples, this information may help determine whether television 300 is operating properly (and/or whether remote control device 400 is operating properly). In some examples, remote control device 400 may also maintain a log of signals received and operations performed, and remote control device 400 may communicate such information to computing system 200 for evaluation by computing system 200. Computing system 200 may use information about signals received by remote control device 400 and operations performed by remote control device 400 to evaluate whether components of testing environment 100 are operating properly.

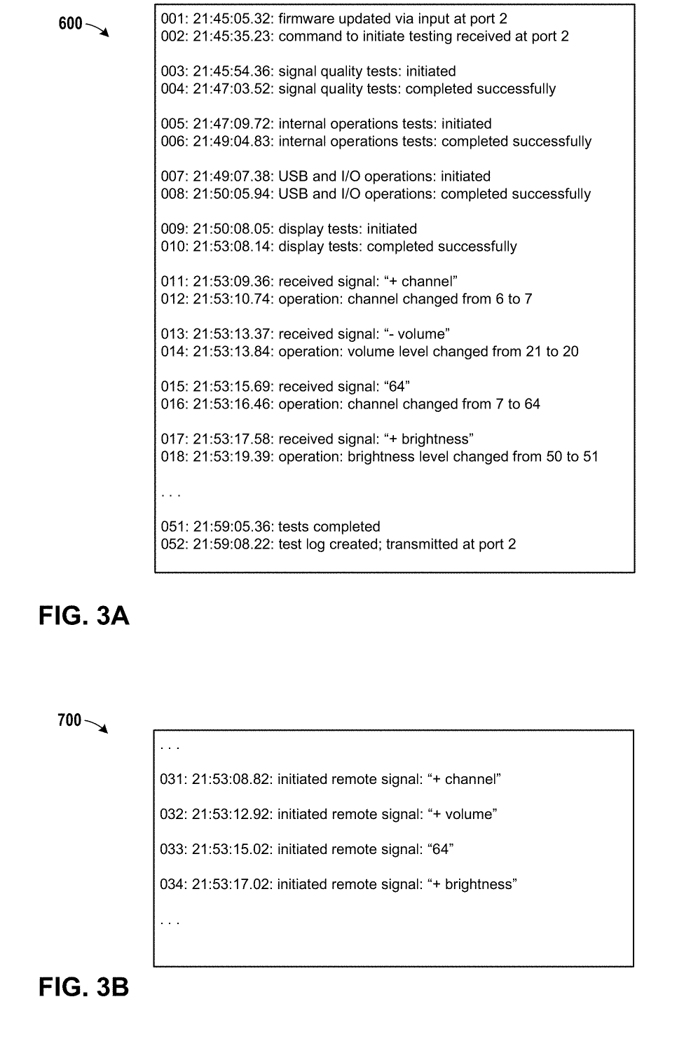

FIG. 3A is a conceptual illustration of an example television operations log 600 that may be generated by an example television 300 in accordance with one or more aspects of the present disclosure. The conceptual illustration of FIG. 3A is described below in the context of FIG. 1 and FIG. 2. FIG. 3A illustrates only an example television operations log 600, and many other examples of television operations log 600 may be generated in other instances and other examples and may take many different forms. In other examples, television operations log 600 may include additional information, and/or in other examples, television operations log 600 might not include all of the items illustrated in FIG. 3A. In some examples, television operations log 600 may include some or all of the information in log 352. Television operations log 600 may include other information not included in log 352.

In the example of FIG. 3A, television operations log 600 may be a time and activity log that may include details of various events, operations, input received, and other log entries. For example, in line 001, television operations log 600 reports that firmware has been updated at port 2. In some examples, this may correspond to computing system 200 copying executable program 265 to television 300, and television 300 performing a firmware update at television 300 using information from input port 2. The example of FIG. 3A is merely illustrative, and in other examples, television operations log 600 may report other information, corresponding to television 300 storing executable program 265 in storage device 340 for execution, or television 300 storing executable program 265 elsewhere, or television 300 executing executable program 265 in another manner.

Television 300 may log the event associated with receiving from computing system 200 a command to initiate testing. See line 002 of FIG. 3A. Television operations log 600 may detail tests that television 300 performs. Such tests may include evaluation of signal quality, internal operations of television 300, integrity tests involving storage device 340 of 300, tests of input device 310, 311, and tests involving evaluation of display quality using sensor 312 (see, e.g., lines 003-010 of television operations log 600). Television operations log 600 may also list various signals that it receives (e.g., from remote control device 400) at communication unit 320, and any operations performed in response to such signals (see, e.g., lines 011-018 of television operations log 600). Television operations log 600 may log the time that tests were completed. Television operations log 600 may also log any other operations performed (e.g., lines 051 to 052 of television operations log 600).

In some examples, television 300 may be able to independently determine whether some or all of the tests performed by television 300 have been performed successfully. For example, television 300 may be able to determine that certain internal operations have been performed correctly, or at least, were performed without encountering an error. Television 300 may also be able to determine whether it responded to certain signals successfully (or without encountering an error). For instance, television 300 may be able to determine whether it responded to a “+ channel” signal appropriately, as in lines 011 and 012 of television operations log 600, because television 300 may be able to determine if the channel has been changed from 6 to 7.

However, in some cases, television 300 might not be able to independently determine whether certain operations have been performed properly. In the example of lines 011 and 012 of television operations log 600, for example, television 300 may receive a signal that it interprets as a “+ channel” signal (e.g., from remote control device 400), but if television 300 is not properly interpreting signals (e.g., from remote control device 400), the signal received may actually be something other than a “+ channel” signal. In some examples, to detect such errors in interpreting signals sent by remote control device 400 (as well as other errors), a computing device, such as computing system 200, may compare or reconcile its operations with the signals sent to television 300 by remote control device 400 in order to verify that television 300 is interpreting such signals properly.

FIG. 3B is a conceptual illustration of an example remote control operations log 700 that may be used by an example computing system 200 to determine whether an example television 300 has operated properly in response to signals sent by an example remote control device 400 in accordance with one or more aspects of the present disclosure. The conceptual illustration of FIG. 3B is described below in the context of FIG. 1, FIG. 2, and FIG. 3A. FIG. 3B illustrates only an example remote control operations log 700, and many other examples of remote control operations log 700 may be generated in other instances and other examples and may take many different forms. In other examples, remote control operations log 700 may include additional information, and/or in other examples, remote control operations log 700 might not include all of the items illustrated in FIG. 3B.

In the example of FIG. 3B, remote control operations log 700 may be a time and activity log of signals sent by remote control device 400. Like television operations log 600, remote control operations log 700 may include a timestamp associated with one or more operations listed in remote control operations log 700. Computing system 200 may compare the information included in remote control operations log 700 with the information in television operations log 600, and determine whether television 300 has operated properly. For instance, at line 032 of remote control operations log 700 suggests that remote control device 400 sent a “+ volume” signal to television 300, but when computing system 200 reconciles this line with the information of television operations log 600 (e.g., using the timestamps included in television operations log 600 and 700), computing system 200 may determine that television 300 improperly interpreted a “+ volume” signal as a “−volume” signal (see line 013 of television operations log 600 and line 032 of remote control operations log 700). Accordingly, computing system 200 may determine that television 300 is not operating properly. This potential error might not be apparent from just remote control operations log 700, but by reconciling television operations log 600 with remote control operations log 700, computing system 200 may determine that one or more errors or improper operations have been performed by television 300. (In some examples, computing system 200, television 300, and remote control device 400 may synchronize any system clocks used to generate television operations log 600 and/or remote control operations log 700, so that the relative order of operations can be properly compared.)

Although television operations log 600 and remote control operations log 700 illustrate how computing system 200 may detect an error relating to television 300 improperly interpreting signals sent by remote control device 400, computing system 200 may be able to determine other types of errors that might be apparent only when information of the type illustrated in television operations log 600 and remote control operations log 700 is evaluated together or reconciled. Further, in other examples, computing system 200 may use information of the type illustrated in television operations log 600 and remote control operations log 700 in other ways, including to verify tests and test results performed by television 300 and/or other operations performed by television 300.

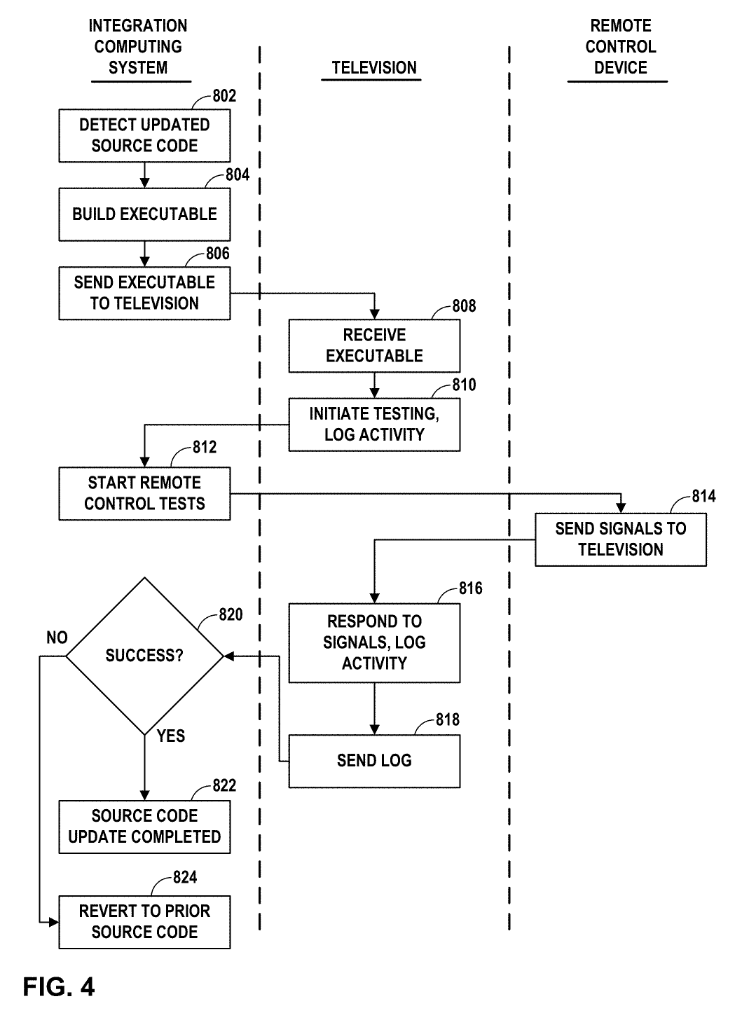

FIG. 4 is a flowchart illustrating an example process of an example testing environment 100 in accordance with one or more aspects of the present disclosure. For purposes of illustration, the process of FIG. 4 is illustrated from three different perspectives: operations performed by an example computing system 200 (left-hand column to the left of dashed line), operations performed by an example television 300 (middle column between dashed lines), and operations performed by an example remote control device 400 (right-hand column to the right of dashed line). For purposes of illustration, FIG. 4 is described in the context of FIG. 1 and FIG. 2. FIG. 4 illustrates only one or more example processes, and many other alternative processes are possible. Specifically, operations described as being performed by a particular device, module, or component in FIG. 4 may, in other examples, be performed by a different device, module, or component.

In FIG. 4, computing system 200 may detect that source code 262 in repository 260 has been updated (802), which may happen as a result of a developer operating developer workstation 110a causing developer workstation 110a to commit source code to repository 260. In response to detecting that source code 262 has been updated, computing system 200 may automatically build executable program 265 (804). In other examples, computing system 200 might not build executable program 265 automatically, but rather, computing system 200 may build executable program 265 at the direction of a user (e.g., at the direction of the developer operating developer workstation 110a).

Computing system 200 may send the newly-built executable program 265 to television 300 (808). Television 300 may receive executable program 265 (808), and may initiate testing (810). In some examples, television 300 may initiate testing automatically as a result of receiving executable program 265. In other examples, television 300 may initiate testing in response to a command received from another computing device (e.g., computing system 200). In some examples, a series of tests may be performed that evaluation internal operations of television 300. Such tests might not require television 300 to respond to signals received from a remote control device. Television 300 may log activity associated with such testing, activities performed, and/or whether operations have been performed properly (810).

Computing system 200 may initiate tests that involve remote control device 400 (812). In some examples, computing system 200 may trigger the start of test script 452 stored at remote control device 400 and executed by remote control device 400. In other examples, computing system 200 may send a test script to remote control device 400, which then executes at remote control device 400. In still other examples, computing system 200 may control remote control device 400 to perform various operations, including causing remote control device 400 to sending signals to television 300. Computing system 200 may initiate such tests before or after television 300 performs internal testing as described above in connection with 810, or in some examples, computing system 200 may initiate such tests while television 300 also performs internal testing. In some cases, television 300 might not perform internal testing, and might only perform tests in response to one or more signals received from an external device (e.g., remote control device 400).

In response to computing system 200 starting remote control tests, remote control device 400 may send signals to television 300 (814). Television 300 may respond to such signals, and log activity associated with the signals, and operations performed in response to such signals (816). Television 300 may send the log of its activity to computing system 200 after testing is completed (818). In some examples, television 300 may send some or all of the information about its activity to computing system 200 as it happens, rather than after testing is complete.

Computing system 200 may evaluate the log of activity to determine whether television 300 is operating properly (820). Such an evaluation may also involve evaluation of additional information, such as information of the type illustrated in remote control operations log 700 described in connection with FIG. 3B. Such an evaluation may involve reconciling the timing of signals sent by remote control device 400 to television 300 and the operations performed by television 300 in response to such signals.

If, based on the evaluation performed by computing system 200, it appears that television 300, remote control device 400, and/or other devices or systems are operating properly, or if no errors were encountered, computing system 200 may finalize updating source code 262 in repository 260 (822). If any errors or improper operations have been encountered, computing system 200 may, in some examples, roll back or revert source code 262 within repository 260 to a prior version of source code 262 (824).

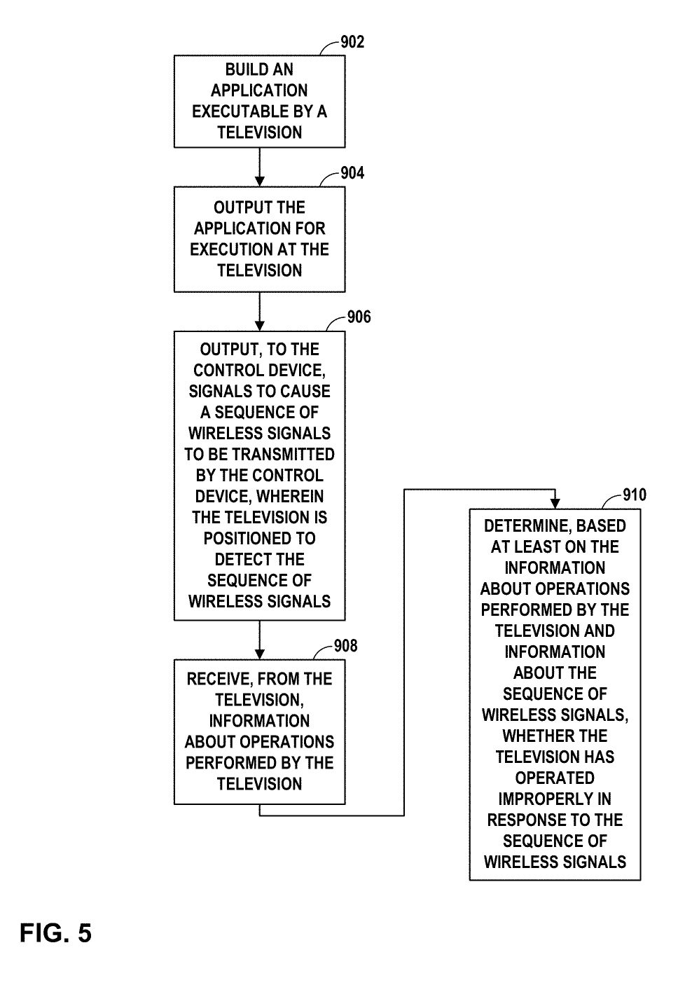

FIG. 5 is a flowchart illustrating an example process of an example computing system 200 in accordance with one or more aspects of the present disclosure. Computing system 200 may build an application executable by a television (902). For example, computing system 200 may build executable program 265 in response to executable program 265 being updated by one or more of developer workstations 110. Computing system 200 may also build executable program 265 in response to input from a user.

Computing system 200 may output the application for execution at the television (904). For example, computing system 200 may send executable program 265 to television 300. Computing system 200 may also cause executable program 265 to start executing on television 300, or in other examples, executable program 265 may begin executing in another way.

Computing system 200 may output, to the control device, signals to cause a sequence of wireless signals to be transmitted by the control device, wherein the television is positioned to detect the sequence of wireless signals (906). For example, computing system 200 may communicate with remote control device 400 to test script 452 executing at remote control device 400.

Computing system 200 may receive, from the television, information about operations performed by the television (908). For example, computing system 200 may receive from television 300 information of the type illustrated in FIG. 3A.

Computing system 200 may determine, based at least on the information about the operations performed by the television and information about the sequence of wireless signals, whether the television has operated improperly in response to the sequence of wireless signals (910). For example, computing system 200 may determine, based on information of the type illustrated in FIG. 3A and FIG. 3B, that television 300 has operated improperly.

For processes described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically might be alternatively not performed automatically, but rather, such operations, acts, steps, or events might be, in some examples, performed in response to input or another event.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A system comprising:
a device capable of transmitting wireless signals;
a television including a processor; and
a computing system capable of communicating with the television and the device,
wherein the computing system includes at least one processor programmed to:
monitor source code stored in a repository,
detect that the source code has been updated in the repository,
in response to detecting that the source code has been updated, build an application executable by the television,
output the application for execution at the television,
output, to the device, signals to cause a sequence of wireless signals to be transmitted by the device, wherein the television is positioned to detect the sequence of wireless signals,
receive, from the television, information about operations performed by the television, and
determine, based at least on the information about operations performed by the television and information about the sequence of wireless signals, whether the television has operated improperly in response to the sequence of wireless signals.

2. The system of claim 1, wherein determining includes reconciling the information about operations performed by the television with timing information associated with the sequence of wireless signals.

3. The system of claim 1, wherein the at least one processor is further programmed to:
after determining whether the television has operated improperly, accepting the source code as a new version in response to determining that the television has not operated improperly.

4. The system of claim 1, wherein the at least one processor is further programmed to:
after determining whether the television has operated improperly, tagging the source code as having completed testing without operating improperly.

5. The system of claim 1, wherein the at least one processor is further programmed to:
after determining whether the television has operated improperly, reverting to an earlier version of the source code in response to determining that the television has operated improperly.

6. The system of claim 1, wherein the sequence of wireless signals is an initial sequence of wireless signals, and wherein the at least one processor is further programmed to:
output, to the device, signals to cause an additional sequence of wireless signals to be transmitted by the device, wherein the additional sequence of wireless signals more exhaustively tests functions of the television than the initial sequence of wireless signals, and wherein the additional sequence of wireless signals requires more time to complete than the initial sequence of wireless signals;
receive, from the television, information about additional operations performed by the television; and
determine, based at least on the information about additional operations performed by the television and information about the additional sequence of wireless signals, whether the television has operated improperly in response to the additional sequence of wireless signals.

7. The system of claim 1, wherein outputting signals includes starting a test script stored at the device so that the test script executes at the device to transmit the sequence of wireless signals.

8. The system of claim 1, wherein outputting signals includes sending a test script to the device and starting the test script so that the test script executes at the device to transmit the sequence of wireless signals.

9. The system of claim 1, wherein outputting signals includes communicating a command to the device for each of the wireless signals in the sequence of wireless signals.

10. The system of claim 1, wherein receiving information about operations performed by the television includes automatically receiving incremental information from the television reporting on one or more operations performed by the television after each of the one or more operations are performed.

11. The system of claim 10, wherein outputting signals includes choosing signals to communicate to the device based on the incremental information.

12. A computer-readable storage medium comprising instructions that, when executed, cause at least one processor of a computing system to:
monitor source code stored in a repository;
detect that the source code has been updated in the repository;
in response to detecting that the source code has been updated, build an application executable by the television;
output the application for execution at the television;
output, to the device, signals to cause a sequence of wireless signals to be transmitted by the device, wherein the television is positioned to detect the sequence of wireless signals;
receive, from the television, information about operations performed by the television; and
determine, based at least on the information about operations performed by the television and information about the sequence of wireless signals, whether the television has operated improperly in response to the sequence of wireless signals.

13. The computer-readable storage medium of claim 12, wherein determining includes reconciling the information about operations performed by the television with timing information associated with the sequence of wireless signals.

14. The computer-readable storage medium of claim 12, wherein the at least one processor is further programmed to:
after determining whether the television has operated improperly, reverting to an earlier version of the source code in response to determining that the television has operated improperly.

15. The computer-readable storage medium of claim 12, wherein the sequence of wireless signals is an initial sequence of wireless signals, and wherein the at least one processor is further programmed to:
output, to the device, signals to cause an additional sequence of wireless signals to be transmitted by the device, wherein the additional sequence of wireless signals more exhaustively tests functions of the television than the initial sequence of wireless signals, and wherein the additional sequence of wireless signals requires more time to complete than the initial sequence of wireless signals;
receive, from the television, information about additional operations performed by the television; and
determine, based at least on the information about additional operations performed by the television and information about the additional sequence of wireless signals, whether the television has operated improperly in response to the additional sequence of wireless signals.

16. The computer-readable storage medium of claim 12, wherein outputting signals includes starting a test script stored at the device so that the test script executes at the device to transmit the sequence of wireless signals.

17. The computer-readable storage medium of claim 12, wherein outputting signals includes at least one of the following: sending a test script to the device and starting the test script so that the test script executes at the device to transmit the sequence of wireless signals, or communicating a command to the device for each of the wireless signals in the sequence of wireless signals.

18. The computer-readable storage medium of claim 12, wherein receiving information about operations performed by the television includes automatically receiving incremental information from the television reporting on one or more operations performed by the television after each of the one or more operations are performed.

19. The computer-readable storage medium of claim 18, wherein outputting signals includes choosing signals to communicate to the device based on the incremental information.

20. A method comprising:
monitoring, by a computer system, source code stored in a repository;
detecting, by the computer system, that the source code has been updated in the repository;
in response to detecting that the source code has been updated, building, by the computer system, an application executable by the television;
outputting, by the computer system, the application for execution at the television;
outputting, to the device by the computer system, signals to cause a sequence of wireless signals to be transmitted by the device;
receiving, by the computer system, from the television, information about operations performed by the television; and
determining, by the computer system, based at least on the information about operations performed by the television and information about the sequence of wireless signals, whether the television has operated improperly in response to the sequence of wireless signals.
